(19) United States
(12) Patent Application Publication
(10) Pub. No.: US 2018/0001754 A1
(43) Pub. Date: Jan. 4, 2018

(54) ANGLED SEAL SURFACE OF A DOOR OF A CABIN

(71) Applicant: Caterpillar Inc., Peoria, IL (US)

(72) Inventors: Emile A. Ghantous, Peoria, IL (US); Jeffrey A. Zurinski, Oglesby, IL (US); David A. Wiese, Peoria, IL (US); Dale B. Higdon, Dunlap, IL (US); Matthew J. Gielda, Peoria, IL (US); Kevin F. Stremlau, Peoria, IL (US); Pedro R. Urias Castro, Garcia (MX)

(73) Assignee: Caterpillar Inc., Peoria, IL (US)

(21) Appl. No.: 15/199,488

(22) Filed: Jun. 30, 2016

(51) Int. Cl. B60J 10/84; B60J 5/04; B60J 10/32

(52) U.S. Cl. CPC B60J 10/84; B60J 10/32; B60J 5/04

(57) ABSTRACT

A cabin assembly may comprises a door assembly comprising an outer surface, an inner surface, and a seal. The cabin assembly may further comprise a cabin frame comprising hinge assemblies pivotably coupling the door assembly to the cabin frame and a seal surface defining an opening into the cabin frame. The seal surface may contact and compress the seal of the door when the door assembly is in a closed position. The seal surface may include an angled seal surface that is provided at an angle with respect to the inner surface of the door assembly. The angled seal surface may be located proximate to the hinge assemblies. The angled seal surface may prevent a portion, of the seal of the door, from being compressed above a threshold when the door assembly is in the closed position.

### TECHNICAL FIELD

The present disclosure generally relates to doors of cabins of machines and, more particularly, relates to a seal surface of the doors.

### BACKGROUND

A door, of a cabin of a machine, may include a seal track and a door seal provided within the seal track. During a closing motion of the door, a portion of the door seal (on a hinge side of the door) may be the first point of contact between the door seal and a corresponding portion of a seal surface of the cabin. As the door moves to a closed position, a side load may be pushing on the portion of the door seal. In the event the contact occurs prematurely, the side load may cause the door seal to be compressed and, consequently, to be displaced out of the seal track. Accordingly, the door seal may be separated from the door and the door seal may be damaged. Additionally, when the door is in the closed position, the compression of the door seal may cause a considerable amount of force (e.g., by an operator) to be required to unlatch the door and bring the door to an opened position. In this regard, the force may be exerted on door handles and/or door latches of the door. Over a period of time, the force may cause the door handles and/or the door latches to be damaged and worn down, and may reduce the life cycle of the door handles and/or the door latches.

International Patent Application Publication No. WO2012017061 (hereinafter the “'061 publication”) is directed to a fire door for separating a driver's cab of a rail vehicle from a passenger compartment of a rail vehicle. The fire door comprises a door frame, a door leaf, a sealing trip on a floor-side edge of the door leaf, and an anti-fire strip which is on the floor-side edge of the door leaf. However, the '061 publication does not disclose or suggest reducing a wear rate of the sealing trip and/or reducing force required to unlatch the fire door. In fact, the '061 publication does not appear to be concerned with the wear rate of the sealing trip and/or the force required to unlatch the fire door.

### SUMMARY OF THE INVENTION

In some embodiments, a cabin assembly may comprise a door assembly comprising an outer surface, an inner surface, and a seal. The cabin assembly may further comprise a cabin frame comprising a plurality of hinge assemblies pivotably coupling the door assembly to the cabin frame, and a seal surface defining an opening into the cabin frame. The opening may be accessible to an operator when the door assembly is in an opened position. The seal surface may contact and compress the seal of the door assembly when the door assembly is in a closed position. The seal surface may include an angled seal surface that is provided at an angle with respect to the inner surface of the door assembly. The angled seal surface may be located proximate to the plurality of hinge assemblies. The angled seal surface may prevent a portion, of the seal of the door assembly, from being compressed above a threshold when the door assembly is in the closed position.

In some embodiments, a machine may comprise a door assembly comprising an outer surface, an inner surface, and a seal. The machine may also comprise a cabin frame comprising a plurality of hinge assemblies pivotably coupling the door assembly to the cabin frame, and a seal surface defining an opening into the cabin frame. The opening may be accessible to an operator when the door assembly is in an opened position. The seal surface may contact the seal of the door assembly when the door assembly is in a closed position. The seal surface may include an angled seal surface that is provided at an angle with respect to the inner surface of the door assembly. The angled seal surface may be located proximate to the plurality of hinge assemblies. The angled seal surface may prevent a portion, of the seal of the door assembly, from being compressed above a threshold when the door assembly is in the closed position.

In some embodiments, a system may comprise a door assembly comprising an outer surface, an inner surface, and a seal. The system may further comprise a cabin frame comprising one or more hinge assemblies pivotably coupling the door assembly to the cabin frame, and a seal surface defining an opening into the cabin frame. The opening may be accessible to an operator when the door assembly is in an opened position. The seal surface may contact the seal of the door assembly when the door assembly is in a closed position. The seal surface may include an angled seal surface that is provided at an angle with respect to the inner surface of the door assembly. The angled seal surface may be located proximate to the one or more hinge assemblies. The angled seal surface may prevent a portion, of the seal of the door assembly, from being compressed above a threshold when the door assembly is in the closed position.

### BRIEF DESCRIPTION OF THE DRAWINGS

FIG. 1 is a side view of a machine according to one embodiment of the present disclosure;

FIG. 2A is a side view of a cabin assembly according to one embodiment of the present disclosure;

FIG. 2B is another side view of the cabin assembly according to one embodiment of the present disclosure;

FIG. 3 is a cross-sectional view of the cabin assembly of FIG. 2A along lines 3-3, according to one embodiment of the present disclosure; and

FIG. 4 is another cross-sectional view of the cabin assembly of FIG. 2A along lines 3-3, according to one embodiment of the present disclosure.

### DETAILED DESCRIPTION

The following detailed description refers to the accompanying drawings. The same reference numbers in different drawings may identify the same or similar elements.

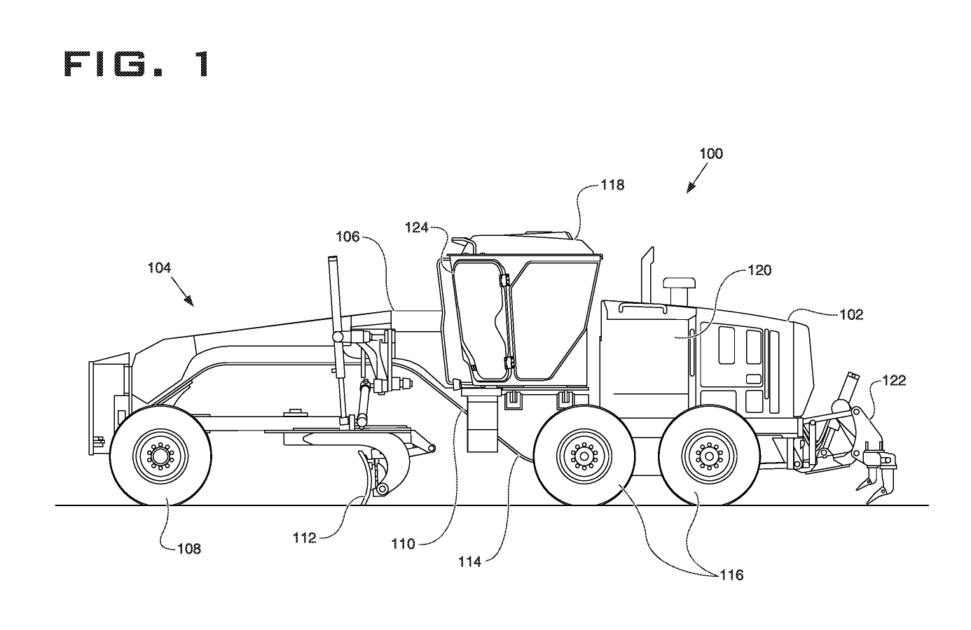

FIG. 1 is a side view of a machine 100 according to one of embodiment of the present disclosure. In some implementations, machine 100 may include an off-highway truck, an on-highway truck, a dump truck, an articulated truck, a loader, an excavator, a pipe layer, a motor grader, and/or the like. Machine 100 may be any machine associated with various industrial applications, including, but not limited to, mining, agriculture, forestry, construction, and/or other industrial applications.

As illustrated in FIG. 1, machine 100 may include a motor grader, although, as explained above, the present disclosure is not limited to motor graders. Machine 100 may include a rear portion 102 and a front portion 104. The front portion 104 may include a front frame section 106, front ground engaging members 108, an articulated joint 110, and a first implement assembly 112, such as a blade or other appropriate attachment, mounted along front frame section 106. Front frame section 106 may extend between the articulated joint 110 and the front ground engaging members 108.

Rear portion 102 may include a rear frame section 114, rear ground engaging members 116, a cabin assembly (or operator cabin assembly) 118, an engine 120, and drive train components (not shown). As illustrated in FIG. 1, in some embodiments, engaging members 116 may be coupled directly to rear frame section 114. In some embodiments, rear ground engaging members 116 may be rotatably mounted on tandem supports that are pivotably mounted along either side of rear frame section 114 at pivot shafts. Rear portion 102 may additionally include a second implement assembly 122, such as a ripper assembly, mounted to rear frame section 114 by an appropriate structure.

In some embodiments, front frame section 106 and rear frame section 114 may be a single frame piece. As illustrated in FIG. 1, a pair of front ground engaging members 108 may be spaced from a plurality of rear ground engaging members 116 which are disposed as pairs along opposite sides of rear frame section 114. In some embodiments, as illustrated in FIG. 1, the pair of front ground engaging members 108 and the plurality of rear ground engaging members 116 may include wheels. In some embodiments, the pair of front ground engaging members 108 and the plurality of rear ground engaging members 116 may be include track assemblies or the like. In some embodiments, alternate arrangements of the pair of front ground engaging members 108 and the plurality of rear ground engaging members 116 may be utilized. For example, the alternate arrangements may include a pair of front wheels and a single pair of rear wheels.

The number of elements shown in FIG. 1 is provided for explanatory purposes. In practice, there may additional elements, fewer elements, different elements, or differently arranged elements than those shown in FIG. 1.

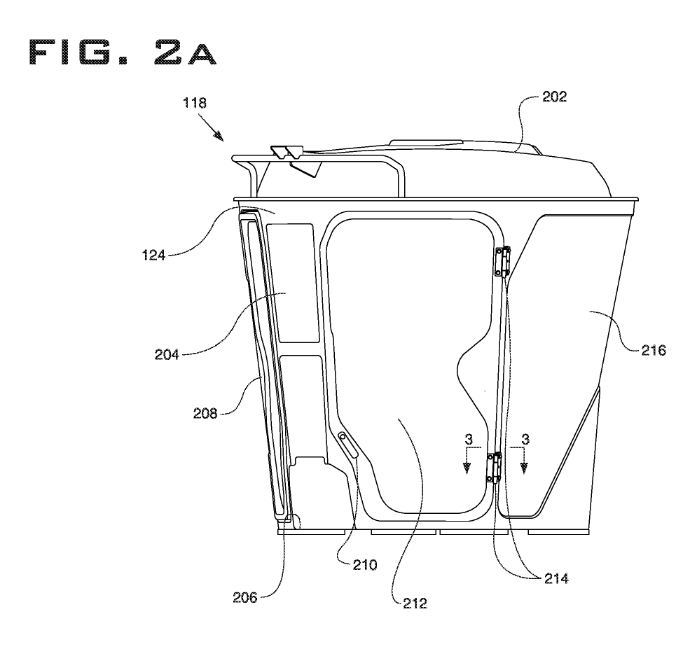

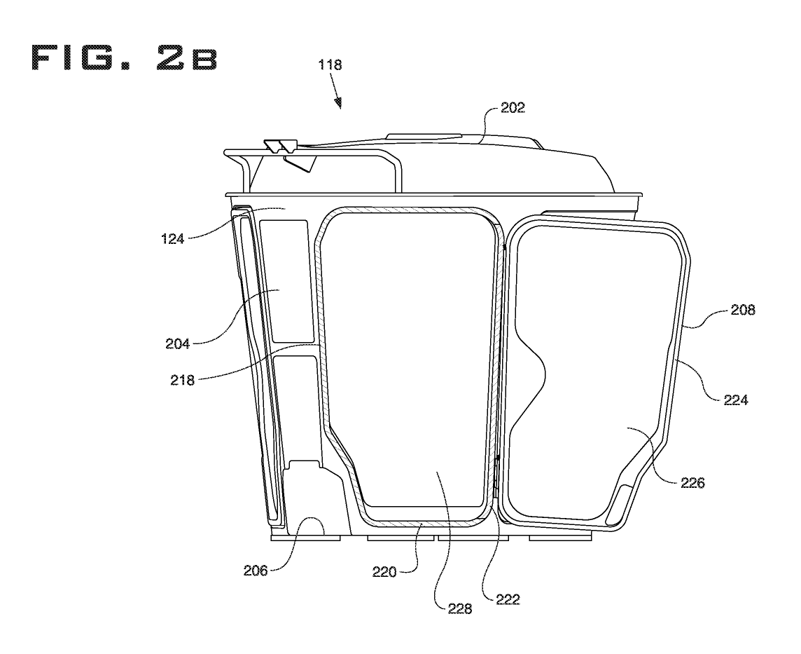

FIG. 2A is a side view of cabin assembly 118 according to one embodiment of the present disclosure. As illustrated in FIG. 2, cabin assembly 118 may include a roof 202 and a floor 206. Cabin assembly 118 may further include a front window 204 and a rear window 216. Front window 204 may provide visibility to an operator of machine 100. For example, front window 204 may provide a front view of a work area. Rear window 216 may also provide visibility to an operator of machine 100. For example, rear window 216 may provide a side view and a rear view of the work area.

Cabin assembly 118 may also include a door assembly 208. In some embodiments, door assembly 208 may include a door handle 210 and an outer surface (or outer panel) 212. In some embodiments, door handle 210 may include any mechanism that may be used to place door assembly 208 in an opened position. In some embodiments, outer surface 212 may include a window that may provide an additional side view of the work area. As illustrated in FIG. 2A, door assembly 208 may be in a closed position. In some embodiments, when door assembly 208 is the closed position, door assembly 208 may be latched using one or more latching mechanisms (e.g., one or more latches).

As illustrated in FIG. 2A, cabin assembly 118 may also include hinge assemblies 214. In some embodiment, door assembly 208 may be pivotably coupled to cabin frame 124 by hinge assemblies 214.

FIG. 2B is another side view of cabin assembly 118 according to one embodiment of the present disclosure. As illustrated in FIG. 2B, cabin assembly 118 may include a seal surface 218. Seal surface 218 may define an opening 228 into an interior portion of cabin assembly 118. In some embodiments, seal surface 218 may include an angled seal surface 222 and a non-angled seal surface 220. Hinge assemblies 214 may be provided proximate to and/or along a portion of seal surface 218. For example, angled seal surface 222 may correspond to the side of seal surface 218 proximate to which (and/or along which) hinge assemblies 214 may be provided.

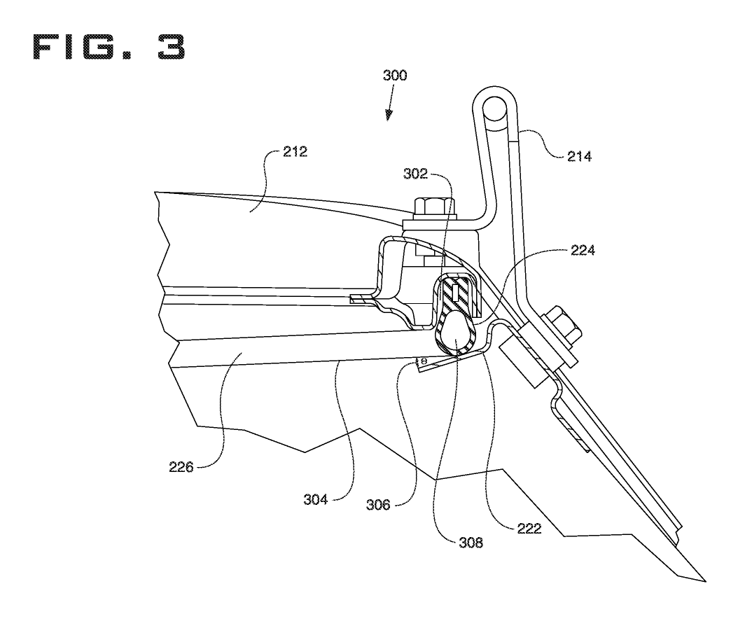

As illustrated in FIG. 2B, door assembly 208 may be in a opened position. In some embodiments, door assembly 208 may include an inner surface (or inner panel) 226 and a seal 224 surrounding inner surface 226. For example, the opened position may correspond to a position in which a portion of inner surface 226 does not contact seal surface 218 so as to enable access to opening 228. In some embodiments, seal 224 may be provided in a seal track 302 (illustrated in FIG. 3) surrounding inner surface 226. In some embodiments, seal surface 218 may contact and/or compress seal 224 when door assembly 208 is in a closed position (as illustrated in FIG. 3). Accordingly, seal 224 may prevent intrusion of elements (e.g., dust particles, water particles, etc.) into cabin assembly 118 via opening 228.

In some embodiments, a door opening mechanism (not shown) may be provided on inner surface 226. The door opening mechanism may include any mechanism that may be used to bring door assembly 208 to the opened position from the closed position. For example, the door mechanism may include a door handle, a door latch, and/or the like. In some embodiments, cabin assembly 118 may also include a seat, a steering apparatus, a speed control apparatus, and a console (each not shown).

FIG. 3 is a cross-sectional view of cabin assembly 118 of FIG. 2A along lines 3-3, according to one embodiment of the present disclosure. As illustrated in FIG. 3, door assembly 208 may be in a closed position. The closed position may correspond to a position in which a substantial portion of inner surface 226 contacts and/or compresses seal surface 218 so as to prevent access to opening 228. As illustrated in FIG. 3, angled seal surface 222 may be provided at an angle 306 (angle θ) with to respect to a bottom surface 304 of inner surface 226. In contrast, non-angled seal surface 220 may be substantially parallel to bottom surface 304. In this regard, angled seal surface 222 may be provided at angle 306 to prevent a portion of seal 224 from being compressed above a seal compression threshold when door assembly 208 is in the closed position. In some embodiments, angle 306 may range from approximately 5 degrees to approximately 30 degrees. For example, angle 306 may range from approximately 10 degrees to approximately 20 degrees. In some instances, angle 306 may be approximately 15 degrees. In some embodiments, the portion of seal 224 may include a particular portion of seal 224 that may contact angled seal surface 222 when door assembly 208 is in the closed position.

In some embodiments, the seal compression threshold may be based on a size of seal 224. For example, the size of seal 224 may include a diameter of a bottom portion 308 of seal 224 and the seal compression threshold may be based on the diameter of bottom portion 308 of seal 224. For instance, the seal compression threshold may correspond to a threshold that prevents the diameter of bottom portion 308 from being decreased (or reduced) by more than approximately 30 percent (30%) when door assembly 208 is in the closed position. In other words, the diameter of bottom portion 308 may be reduced by more than approximately 30 percent when seal 224 is compressed above the seal compression threshold. Conversely, the diameter of bottom portion 308 may be reduced by less than approximately 30 percent when seal 224 is compressed below the seal compression threshold.

Additionally, or alternatively, the seal compression threshold may be based on a displacement of seal 224 out of seal track 302. For example, seal 224 may roll out or may be displaced out of seal track 302 when seal 224 is compressed above the seal compression threshold. Conversely, seal 224 may remain within seal track 302 when seal 224 is compressed below the seal compression threshold.

Additionally, or alternatively, the seal compression threshold may be based on a target force required to bring door assembly 208 to the opened position from the closed position. For example, a force exceeding the target force may be required to bring door assembly 208 from the closed position to the opened position when seal 224 is compressed above the seal compression threshold. Conversely, a force not exceeding the target force may be required to bring door assembly 208 from the closed position to the opened position when seal 224 is compressed below the seal compression threshold. In some embodiments, the target force may range from approximately 0 newton to approximately 200 newtons. For example, the target force may range from approximately 0 newton to approximately 100 newtons.

In some embodiments, angle 306 may be based on the size of seal 224, the displacement of seal 224 out seal track 302, and/or the target force required to bring door assembly 208 to the opened position from the closed position in manner similar to the manner described above with respect to the seal compression threshold.

Based on angled seal surface 222 being provided at angle 306 with to respect to bottom surface 304 of inner surface 226, a portion of seal 224 (which may be a first point of contact between seal 224 and seal surface 218) may be prevented from being compressed above a threshold when door assembly 208 is in the closed position. Moreover, based on angled seal surface 222 being provided at angle 306 with to respect to bottom surface 304, contact between the portion of the seal and seal surface 218 and, more particularly, angled seal surface 222 may be delayed as door assembly 208 is being moved to the closed position. Accordingly, the portion of seal 224 may be prevented from being compressed above the seal compression threshold and being displaced out of seal track 302, thereby reducing damage to and a wear rate of seal 224 (e.g., reducing a rate at which seal 224 is worn down) and extending a life cycle of seal 224. Additionally, and/or alternatively, the force (e.g., by an operator) required to unlatch door assembly 208 and bring door assembly 208 from the closed position to the opened position may be reduced to a range corresponding to the target force. Accordingly, damage to and wear of door handles and/or door latches, of door assembly 208, may be reduced and a life cycle of the door handles and/or the door latches may be extended.

While the present disclosure has been referring to angled seal surface 222 being provided at angle 306 with to respect to bottom surface 304 of inner surface 226, in some embodiments, a portion of inner surface 226 may be provided at angle 306 with respect to angled seal surface 222. The portion of inner surface 226 may include a portion that may contact angled seal surface 222. In such instance, angled seal surface 222 may be substantially parallel to bottom portion 304. Additionally, or alternatively, while the present disclosure has been referring to seal track 302 surrounding inner surface 226, in some embodiments, seal track 302 may be provided on and may surround seal surface 218. In such instance, seal 224 may be provided within seal track 302. The above alternative configurations may provide benefits similar to the benefits described above with respect to extending the life cycle of seal 224 and extending the life cycle of the door handles and/or the door latches.

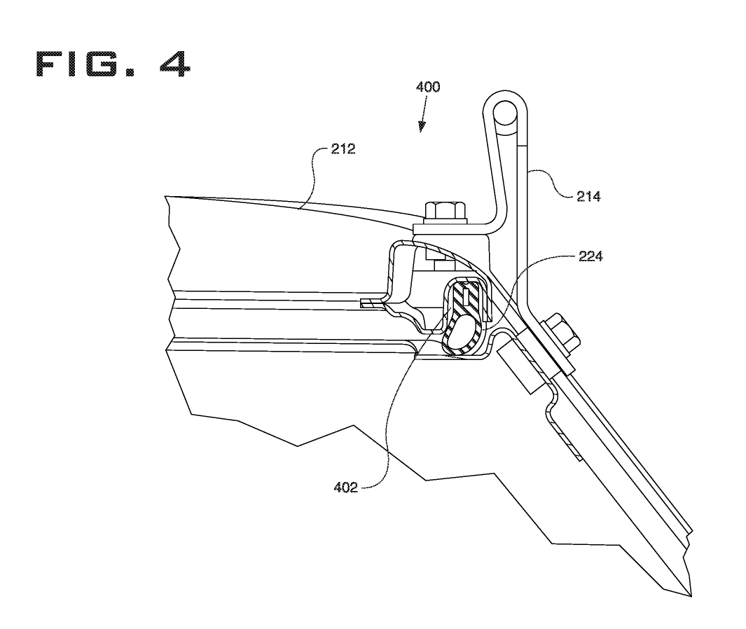

FIG. 4 is another cross-sectional view of cabin assembly 118 of FIG. 2A along lines 3-3, according to one embodiment of the present disclosure. The configuration of cabin assembly 118 in FIG. 4 may be similar to the configuration of cabin assembly 118 in FIG. 3. However, as illustrated in FIG. 4, angled seal surface 222 may be substantially parallel to bottom portion 304. Additionally, as illustrated in FIG. 4, a portion of seal 224 may be provided at an angle (instead of angled seal surface 222 being provided at an angle). In some implementations, the angle may be similar to angle 306. The above alternative configurations of FIG. 4 may provide benefits similar to the benefits described above with respect to extending the life cycle of seal 224 and extending the life cycle of the door handles and/or the door latches.

No element, act, or instruction used herein should be construed as critical or essential unless explicitly described as such. As used herein, the articles “a” and “an” are intended to include one or more items, and may be used interchangeably with “one or more.” Furthermore, as used herein, the term “set” is intended to include one or more items, and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

### INDUSTRIAL APPLICABILITY

The present disclosure finds utility in various industrial applications, such as in transportation, mining, construction, industrial, earthmoving, agricultural, forestry machines and equipment, and/or the like. For example, the present disclosure may be applied to doors of cabins of hauling machines, dump trucks, mining vehicles, on-highway vehicles, off-highway vehicles, trains, motor graders, loaders, excavators, earth-moving vehicles, dozers, tractors, backhoes, agricultural equipment, material handling equipment, power generators, and/or the like.

More specifically, the present disclosure may find applicability in reducing a wear rate of seal 224 (e.g., reducing a rate at which seal 224 is worn down), thereby extending the life cycle of seal 224. Additionally, and/or alternatively, the present disclosure may find applicability in reducing the force required to unlatch door assembly 208 and bring door assembly 208 from the closed position to the opened position. Accordingly, damage to and wear of door handles and/or door latches, of door assembly 208, may be reduced and a life cycle of the door handles and/or the door latches may be extended.

1. A cabin assembly comprising:
a door assembly comprising an outer surface, an inner surface, and a seal; and
a cabin frame comprising:
a plurality of hinge assemblies pivotably coupling the door assembly to the cabin frame, and
a seal surface defining an opening into the cabin frame,
the opening being accessible to an operator when the door assembly is in an opened position,
the seal surface contacting and compressing the seal of the door assembly when the door assembly is in a closed position,
the seal surface including an angled seal surface that is provided at an angle with respect to the inner surface of the door assembly,
the angle being based on one or more of a size of the seal of the door assembly or a displacement of the seal,
the angled seal surface being located proximate to the plurality of hinge assemblies,
the angled seal surface preventing a portion, of the seal of the door assembly, from being compressed above a threshold when the door assembly is in the closed position.

2. The cabin assembly of claim 1, where the angle ranges from approximately 5° to approximately 30°.

3. The cabin assembly of claim 1, where the angle ranges from approximately 10° to approximately 20°.

4. The cabin assembly of claim 3, where the angle is approximately 15°.

5. The cabin assembly of claim 1, where the threshold is based on the size of the seal.

6. The cabin assembly of claim 5, where the size of the seal includes a diameter of a bottom portion of the seal.

7. The cabin assembly of claim 1, where the door assembly further comprises a seal track,
where the seal is provided within the seal track, and
where the threshold is based on a displacement of the seal out the seal track.

8. The cabin assembly of claim 1, where the threshold is based on a target force required to bring the door assembly to the opened position from the closed position.

9. A machine comprising:
a door assembly comprising an outer surface, an inner surface, and a seal; and
a cabin frame comprising:
a plurality of hinge assemblies pivotably coupling the door assembly to the cabin frame, and
a seal surface defining an opening into the cabin frame,
the opening being accessible to an operator when the door assembly is in an opened position,
the seal surface contacting the seal of the door assembly when the door assembly is in a closed position,
the seal surface including an angled seal surface that is provided at an angle with respect to the inner surface of the door assembly,
the angle being based on one or more of a size of the seal, a displacement of the seal, or a target force required to bring the door assembly to the opened position from the closed position,
the angled seal surface being located proximate to the plurality of hinge assemblies,
the angled seal surface preventing a portion, of the seal of the door assembly, from being compressed above a threshold when the door assembly is in the closed position.

10. The machine of claim 9, where the angle ranges from approximately 5° to approximately 30°.

11. The machine of claim 9, where the angle is approximately 15.

12. The machine of claim 9, where the angle ranges from approximately 10° to approximately 20°.

13. The machine of claim 9, where the threshold is based on the size of the seal.

14. The machine of claim 9, where the door assembly further comprises a seal track,
where the seal is provided within the seal track, and
where the threshold is based on the displacement of the seal out of the seal track.

15. The machine of claim 9, where the threshold is based on the target force required to bring the door assembly to the opened position from the closed position.

16. The machine of claim 15, where the target force ranges from approximately 0 newton to 100 newtons.

17. A system comprising:
a door assembly comprising an outer surface, an inner surface, and a seal; and
a cabin frame comprising:
one or more hinge assemblies pivotably coupling the door assembly to the cabin frame, and
a seal surface defining an opening into the cabin frame,
the opening being accessible to an operator when the door assembly is in an opened position,
the seal surface contacting the seal of the door assembly when the door assembly is in a closed position,
the seal surface including an angled seal surface that is provided at an angle with respect to the inner surface of the door assembly,
the angle being based on one or more of a size of the seal, a displacement of the seal, or a target force required to bring the door assembly to the opened position from the closed position,
the angled seal surface being located proximate to the one or more hinge assemblies,
the angled seal surface preventing a portion, of the seal of the door assembly, from being compressed above a threshold when the door assembly is in the closed position.

18. The system of claim 17, where the angle ranges from approximately 5° to approximately 30°.

19. The system of claim 17, where the seal is provided within a seal track of the door assembly, and
where the threshold is based on one or more of:
the size of the seal, or
the displacement of the seal out of the seal track.

20. The system of claim 17, where the threshold is based on the target force required to bring the door assembly to the opened position from the closed position, and
where the target force ranges from approximately 0 newton to 100 newtons.
